(19) United States
(12) Patent Application Publication
(10) Pub. No.: US 2023/0329337 A1
(43) Pub. Date: Oct. 19, 2023

(54) AEROSOL PROVISION DEVICE

(71) Applicant: Nicoventures Trading Limited, LONDON (GB)

(72) Inventors: Thomas LEAH, London (GB); Benjamin TAYLOR, London (GB); Luke WARREN, London (GB); Matthew HODGSON, London (GB); Jeremy CAMPBELL, London (GB)

(21) Appl. No.: 18/041,897

(22) PCT Filed: Aug. 17, 2021
(86) PCT No.: PCT/EP2021/072854

§ 371 Date: Feb. 16, 2023

(30) Foreign Application Priority Data
Aug. 17, 2020 (GB) 2012831.0

(51) Int. Cl. A24F 40/40; A24F 40/20; A24F 7/02; A24F 40/95

(52) U.S. Cl. CPC A24F 40/40; A24F 40/20; A24F 7/02; A24F 40/95; A24F 40/46

(57) ABSTRACT

The application relates to an aerosol provision device. The device comprises a body, a mouthpiece and an attachment means. The body comprises a chamber formed in the body and configured to partially receive an article comprising an aerosol-generating material such that a portion of the article protrudes from the body. The mouthpiece comprises a passage circumscribed by a wall, the passage configured to receive the protruding portion of the article. The attachment means is configured to removably attach the mouthpiece to the body and bring the mouthpiece into engagement with the body, and the protruding portion of the article contacts the wall of the passage when the mouthpiece is engaged with the body.

### PRIORITY CLAIM

The present application is a National Phase entry of PCT Application No. PCT/EP2021/072854, filed Aug. 17, 2021, which claims priority from GB Application No. 2012831.0, filed Aug. 17, 2020, each of which hereby fully incorporated herein by reference.

### TECHNICAL FIELD

The present disclosure relates to aerosol provision devices, aerosol provision systems comprising an aerosol provision device, and methods of arranging an aerosol provision device.

### BACKGROUND

Smoking articles such as cigarettes, cigars and the like, burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

According to a first aspect of the present disclosure, there is provided an aerosol provision device, comprising:

a device body;

a chamber formed in the device body and configured to partially receive an article comprising an aerosol-generating material such that a portion of the article protrudes from the device body;

a mouthpiece comprising a passage circumscribed by an interior wall, the passage configured to receive the protruding portion of the article; and

an attachment means configured to attach the mouthpiece to the device body and bring the mouthpiece into engagement with the device body, the device configured such that the protruding portion of the article partially received within the chamber contacts the interior wall of the passage when the mouthpiece is engaged with the device body.

According to a second aspect of the present disclosure, there is provided an aerosol provision device system comprising:

the aerosol provision device of the first aspect; and

a carry case comprising a body and a cavity formed in the body, the cavity sized to receive the device.

Further features and advantages of the disclosure will become apparent from the following description of embodiments of the disclosure, given by way of example only, which is made with reference to the accompanying drawings.

### BRIEF DESCRIPTION OF THE DRAWINGS

FIG. 1a shows a perspective view of a device according to an embodiment.

FIG. 1b shows another perspective view of the device of FIG. 1a.

FIG. 1c shows a partial, enlarged view of the device of FIG. 1a

FIG. 2a shows a perspective view of a device system according to an embodiment.

FIG. 2b shows a perspective view of the device system of FIG. 2a.

### DETAILED DESCRIPTION

As used herein, the term “aerosol-generating material” includes materials that provide volatilized components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

Apparatus is known that generates aerosol from an aerosol-generating material using an aerosol generator. One particularly common way of generating aerosol is by heating the aerosol-generating material. In such an apparatus, the aerosol generator is a heater which heats aerosol-generating material to volatilize at least one component of the aerosol-generating material, typically to form an aerosol which can be inhaled, without burning or combusting the aerosol-generating material. Such apparatus is sometimes described as an “aerosol provision device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine. The aerosol-generating material may be in the form of or be provided as part of a rod, cartridge or cassette or the like which can be inserted into the apparatus. An aerosol generator for volatilizing the aerosol-generating material may be provided as a “permanent” part of the apparatus or could be combined with the aerosol-generating material in a replaceable or consumable component. In the present disclosure, the focus will be on an aerosol generator which is a heater; however, it should be understood that alternative ways of generating aerosol from an aerosol-generating material are also available.

An aerosol provision device can receive an article comprising aerosol-generating material for heating. An “article” in this context is a component that includes or contains, in use, the aerosol-generating material, which is heated to volatilize the aerosol-generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article. Alternatively, aerosol-generating material can simply be located in a free or unconstrained manner in a heating chamber of a device; loose leaf tobacco, for example, could be used in this way.

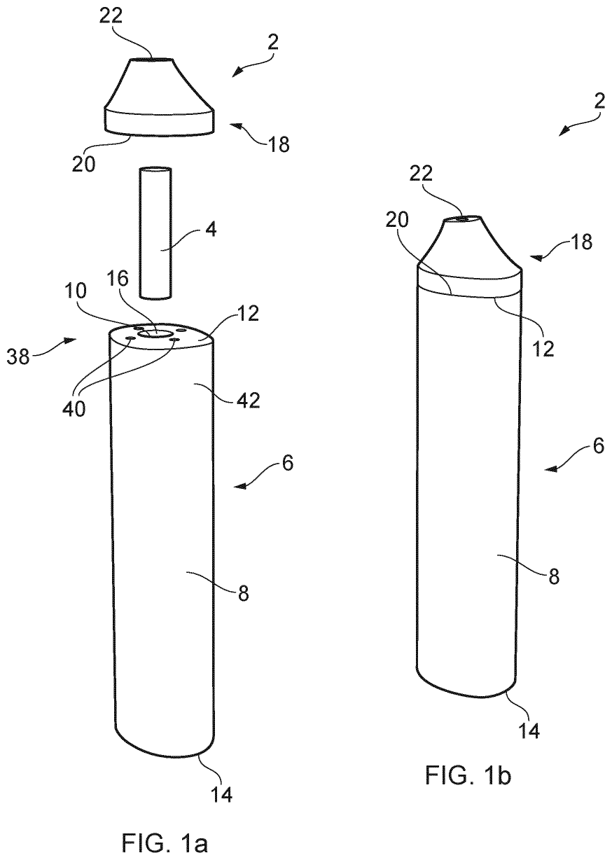

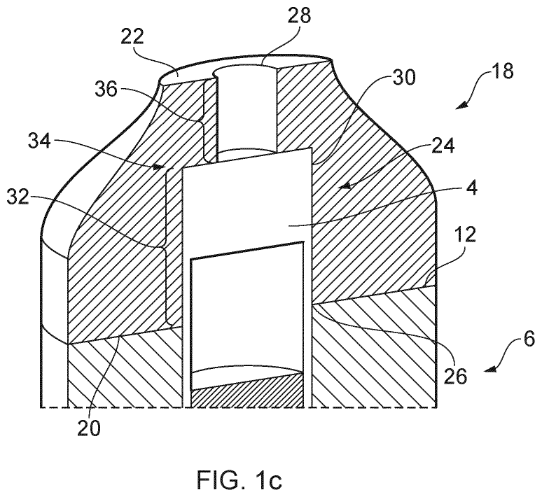

FIGS. 1a and 1b show an aerosol provision device 2 for generating aerosol from an aerosol generating material. The aerosol provision device 2 is configured to receive a replaceable article 4 (or consumable) comprising the aerosol generating material, and to generate an aerosol or inhalable medium from the material to be inhaled by the device user.

The aerosol provision device 2 comprises a body 6 having a housing 8 (or outer cover) which surrounds and houses various components of the device 2 within the body 6. The device 2 comprises a chamber 10 within the housing 8 for receiving the article 4 into the device 2. The body 6 has a first end 12, which may comprise a substantially flat or planar surface. The first end 12 may also be referred to as the proximal end, as the end is closest to the user during use of the device. The body 6 further comprises an opposed second, or distal, end 14.

An opening 16 is formed through the housing 8 at the first end 12 of the body 6, the opening 16 connecting the chamber 10 to an exterior of the housing 8. The article 4 may be inserted into the chamber 10 through this opening 16 in the first end 12. The chamber 10 is sized and shaped to receive the article 4 in a sliding fit. The chamber 10 may have a corresponding shape to that of the intended article 4, for example a cylindrical shape, and may be sized to have a cross-sectional area slightly larger than that of the article 4 in order to receive and hold the article 4 in a sliding fit.

In the inserted state, the article 4 is only partially received by the chamber 10; that is, a portion of the article 4 protrudes out of the chamber 10 through the opening 16 to extend outwardly of the housing 8 away from the first end 12 of the body 6.

The device 2 further comprises a one or more aerosol generators (not shown) within the housing 8 of the body 6. In use, the aerosol generators interact with the article 4 to generate an aerosol. In an embodiment, one or more of the aerosol generators comprise a heater, which is configured to heat the article 4 to generate aerosol. One or more of the aerosol generators may comprise one or more of a resistive heater, infra-red heater or a ceramic heater. Alternatively or additionally, one or more of the aerosol generators may comprise an inductive heater. The inductive heater may comprise a susceptor including a ferrous material, the susceptor in heat communication with the chamber 10 where the article 4 is received. The inductive heater further comprises a magnetic field generator, for example an induction coil, which generates a magnetic field in the susceptor to heat the susceptor and thereby heat the chamber 10 and the article 4 therein.

The device 2 further comprises a power source (not shown) disposed within the housing 8 of the body 6. The power source may comprise a battery, for example a rechargeable battery. The power source is in communication with the one or more aerosol generators for powering the one or more aerosol generators to generate aerosol from the article 4.

The device 2 may also include an input interface (not shown), which may comprise a button or switch, which operates the device 2 when pressed. For example, a user may turn on the device 2 by operating the input interface. The input interface may be formed as part of the housing 8. The input interface allows the user to activate the one or more aerosol generators as described above.

The device 2 may also comprise an electrical connector/component (not shown), such as a socket/port, which can receive a cable to charge the power source of the device 2, for example a rechargeable battery, which is disposed in the body 6. For example, the socket may be a charging port, such as a USB charging port. In some examples the socket may be used additionally or alternatively to transfer data between the device 2 and another device, such as a computing device. The socket may be arranged in the housing 8.

The device 2 further comprises a mouthpiece 18 which engages with the housing 8 of the body 6 at the first end 12 thereof. The mouthpiece 18 comprises a first, or distal, end 20, which forms a substantially flat surface which abuts the substantially flat surface of the first end 12 of the body 6. The mouthpiece 18 extends from the first end 20 to a second, or proximal, end 22 configured for the user to draw on and inhale aerosol from.

The mouthpiece 18 of the pictured embodiment is completely removable from, and replaceable to, the housing 8 by the user. When the mouthpiece 18 of the device 2 is removed from the first end 12 of the body 6 it is unattached to any portion of the body 6 or housing 8 thereof. When the mouthpiece 18 is replaced onto the body 6, it can be re-engaged with the housing 8 at the first end 12 of the body 6.

In other embodiments, the mouthpiece 18 may be partially removable from the body 6 by the user. When the mouthpiece 18 of the device 2 is partially removed from the first end 12 of the body 6, it remains partially attached to the body 6, for example by a hinge which is attached to the housing 8 and to the mouthpiece 18. The mouthpiece 18 may then be fully re-engaged with the first end 12 of the body 6 by the user.

In other embodiments, the mouthpiece may be partially removable and partially connected to the device body by way of a mechanism other than a hinge. In one embodiment the mouthpiece may be connected to the device body by a slide mechanism, which allows the mouthpiece to slide relative to the device body while remaining attached to the body via the mechanism. In another embodiment, the mouthpiece may be rotatable or twistable relative to the device body in order to expand and contract the mouthpiece. This mechanism allows for the article to be inserted into the chamber of the device body while the mouthpiece is in an expanded position, partially removed from the body.

As best seen in FIG. 1c, the mouthpiece 18 comprises a passage 24 which extends from a first opening 26 in the first, distal end 20 to a second opening 28 in the second, proximal end 22. When the mouthpiece 18 is engaged to the first end 12 of the body 6 and an article 4 is partially received by the chamber 10 in the housing 8, the remaining or protruding portion of the article 4 is received by the mouthpiece 18 through the first opening 26 in the first, distal end 20, and into the passage 24.

The passage 24 defines an interior wall 30 which circumscribes the passage 24. When the mouthpiece 18 is engaged to the first end 12 of the body 6, the article 4 contacts the interior wall 30 of the passage 24 so as to form a seal with the interior wall 30. The article 4 may contact the interior wall 30 around substantially the full circumference of the interior wall 30, so as to form a sealing contact which fully circumscribes the passage 24. The engagement between the article 4 and the interior wall 30 may be so as to partially or fully seal the passage 24 to limit or prevent the free movement of aerosol or air through the passage 24 past the sealing contact.

The article 4 has a sidewall. The sidewall defines the periphery of the article. The sidewall extends circumferentially. The sidewall of the portion of the article 4 that protrudes into the mouthpiece 18 contact the interior wall 30 around the periphery. The sidewall and interior wall are in contact along a longitudinally extending length. The sidewall extends in contact at least substantially the circumference of the interior wall 30, so as to form a sealing contact which fully circumscribes the passage 24. In embodiments, the sidewall extends parallel to and contact the interior wall 30 along substantially the length of the first portion 32 of the passage 24, forming a sealing arrangement along the length of the first portion 32 of the passage 24. The engagement between the sidewall of the article 4 and the interior wall 30 may aid to partially or fully seal the passage 24 to limit or prevent the free movement of aerosol or air through the passage 24 past the sealing contact.

The sealing contact may be formed due to the shape and size of the passage 24 relative to the article 4. The passage 24 may have a cross-sectional shape which corresponds to a cross-sectional shape of the article 4, so as to receive the article 4 therein. For example, both the passage 24 and article 4 may comprise a circular cross-section, each forming cylindrical shapes. The passage 24 cross-sectional size may be slightly smaller than the cross-sectional size of the article 4, so that the article 4 forms a press-fit with the interior wall 30 of the passage 24 and a sealing contact as described above.

The passage 24 may comprise a changing cross-section along the length between the distal end opening 26 and the proximal end opening 28. In the example shown, the passage 24 comprises a first, or distal portion 32 with a first cross-section and a second, or proximal portion 36 with a second cross-section, where the area of the first cross-section is larger than the area of the second cross-section. The first portion 32 of the passage 24 extends from the distal end opening 26 to partway along the full length of the passage 24 up to a transition portion 34 of the interior wall 30. The second portion 36 extends from the transition portion 34 of the interior wall 30 to the proximal end opening 28.

In the illustrated embodiment, the transition portion 34 of the interior wall 30 comprises a section of the interior wall 30 which generally perpendicularly to the direction of the passage 24, forming an abutment. In other embodiments, the transition portion 34 may comprise an angled section of the interior wall 30 with respect to the direction of the passage 24, so as to form a gradual slope. The article 4 may form a sealing contact with the interior wall 30 at the transition portion 34, for example against the abutment or against the slope.

The first portion 32 of the passage 24 is configured to receive the article 4 so that the interior wall 30 in the first portion contacts the article 4 in the manner described above. As such, the first portion 32 of the passage 24 may be sized to have a cross-sectional size slightly smaller than the cross-sectional size of the article 4 so as to form the sealing contact. The second portion 36 is sized to be smaller than the first portion 32 so that the article 4 is prevented from being inserted fully through the passage 24 and out of the second, proximal end 22 of the mouthpiece 18.

The device 2 comprises an attachment means 38 which removably attaches the mouthpiece 18 to the housing 8. The attachment means 38 generates a force which brings the mouthpiece 18 into bearing with the housing 8 at the first end 12 of the body 6 and the first, distal end 20 of the mouthpiece 18. By bringing the mouthpiece 18 into bearing with the housing 8 of the device body 6, the attachment means 38 helps to form the contact between the interior wall 30 of the mouthpiece passage 24 and the article 4, which in turn forms the sealing contact.

In embodiments, the attachment means 38 may comprise a magnet. In the embodiment shown, the attachment means 38 comprises a plurality of magnets 40. The illustrated plurality of magnets 40 includes a plurality of magnets 40 which are disposed in or on the housing 8 at the first end 12 of the body 6 and a plurality of magnets (not shown) which are disposed in the first, distal end 20 of the mouthpiece 18. The two pluralities of magnets are arranged to attract one another, i.e. by having opposed polarities, and so bring the first, distal end 20 of the mouthpiece 18 into bearing with the housing 8 at the first end 12 of the body 6

The magnets 40 are recessed into the respective first end 12 of the body 6 and distal end 20 of the mouthpiece 18 so that the housing 8 of the body 6 and the mouthpiece 18 may form a flush contact along their respective surfaces. In other embodiments, the magnet, magnets or ferrous material may be disposed under a surface of the housing 8 at the first end 12 of the body 6 and under a surface of the first, distal end 20 of the mouthpiece 18 so as to be covered by the surfaces and obscured from visibility. The magnets, although covered, will still attract and being the mouthpiece 18 and housing 8 together.

The plurality of magnets in the mouthpiece first, distal end 20 are arranged in a ring shape around the first opening 26 which is formed therein, and the plurality of magnets 40 in the housing 8 at the first end 12 of the device body 6 are similarly arranged in a ring shape around the opening 16 to the chamber 10. The pluralities of magnets 40 in the housing 8 and the mouthpiece 18 are arranged in a corresponding manner to one another so that each magnet 40 in the housing 8 aligns with one magnet of the mouthpiece 18 when the mouthpiece 18 is in engagement with the housing 8. In the embodiment shown, there are four magnets disposed in each of the first end 12 of the device body 6 and the first, distal end 20 of the mouthpiece 18.

In other embodiments, only one of the mouthpiece 18 or the housing 8 of the body 6 may comprise a magnet or a plurality of magnets. In such an embodiment, the respective other of the housing 8 or the mouthpiece 18 comprises a region of ferrous material in the first end 12 of the body 6 or the first, distal end 20 of the mouthpiece 18, so as to engage with the magnets of the other. The region of ferrous material may comprise a strip of ferrous material recessed into the first end 12 of the body 6 or the first, distal end 20 of the mouthpiece 18. Alternatively, substantially a whole surface of the first end 12 of the body 6 or the first, distal end 20 of the mouthpiece 18 could comprise a ferrous material.

Other attachment means are envisaged as within the scope of the disclosure. For example, the housing 8 and mouthpiece 18 may comprise respective screw and thread connections, so that the mouthpiece 18 and the housing 8 could be brought into bearing by a threaded connection.

In use, the user removes the mouthpiece 18 from the housing 8 of the device 2 so as to expose the opening 16 in the first end 12 and the chamber 10. The user inserts the article 4 into the chamber 10 through the opening 16. The user then replaces the mouthpiece 18 onto the housing 8 at the first end 12 of the body 6; the protruding portion of the article 4 is received within the passage 24 of the mouthpiece 18 through the first opening 26 formed in the first, distal end 20 of the mouthpiece 18, and the first, distal end 20 of the mouthpiece 18 is brought into bearing with the housing 8 at the first end 12 of the body 6 by the attachment means 38. The article 4 forms a sealing contact with the interior surface of the passage 24 of the mouthpiece 18 in the manner described above.

The user may then turn on the device 2, or otherwise cause the device 2 to activate the one or more aerosol generators. The one or more aerosol generators interacts with the portion of the article 4 which is disposed within the chamber 10 to form an aerosol, as described above. The aerosol passes up through the article 4 and emerges from the article into the passage 24 of the mouthpiece 18, at a location which is past the sealing contact in the proximal direction. The sealing contact ensures that the aerosol does not travel backwards down the mouthpiece passage 24 towards the first, distal end 20, but instead is directed towards the second, proximal end 22 of the mouthpiece 18 and the second opening 28, where the user may inhale the aerosol.

Once the user has finished a use or session with the device 2, the mouthpiece 18 may be removed from the housing 8 again, and the article 4 may be removed from the chamber 10 and disposed of. The device 2 is then ready to receive another article 4 for a subsequent use.

It should be understood that, in embodiments where the mouthpiece 18 is only partially removable from the housing 8, the step of removing the mouthpiece 18 described above may comprise partially removing the mouthpiece 18 to expose the chamber 10.

By receiving the consumable article 4 directly into the mouthpiece 18, the device 2 may provide a compact aerosol-generation solution. The contact between the article 4 and mouthpiece 18 provides direction of generated aerosol towards the user, to improve user experience. The use of a mouthpiece 18 may further improve user experience by providing a separation between the consumable and the user, for example by reducing the heat of the aerosol below levels which would be uncomfortable for the user.

By using an attachment means, the device body 6 and mouthpiece 18 are easily and reliably brought together into contact by the user, ensuring that a seal is created when the user operates the device 2. Magnetic attachment means in particular helps to ensure that the mouthpiece 18 is properly fitted by the user in the correct position, as the magnetic force provided by the attachment means brings the mouthpiece 18 into position automatically. The magnetic attachment means also provides an appropriate force to bear the mouthpiece 18 against the article 4 to create the necessary sealing contact by press-fitting the article 4 into the mouthpiece 18, and does so with reduced potential for user error.

In an embodiment, the device 2 may comprise a secondary attachment means 42 for attaching the mouthpiece 18 to the housing 8 at a location on the body 6 other than the first end 12 of the body 6. For example, the secondary attachment means 42 may be arranged in or on the housing 8 at one lateral side of the body 6.

In embodiments where the attachment means 38 comprises a magnet or magnets, the secondary attachment means 42 may also comprise a magnet or magnets or a region of ferrous material which is disposed on or in the housing 8. The magnet, magnets or ferrous material which is disposed in the mouthpiece 18 to form part of the attachment means 38 can therefore attach the mouthpiece 18 to the housing 8 away from the first end 12 of the body 6.

In use, the user may use the secondary attachment means 42 to hold the mouthpiece 18 to the housing 8 subsequent to removing the mouthpiece 18 from the housing 8 at the first end 12 of the body 6, and prior to inserting the article 4 into the chamber 10. The secondary attachment means 42 thereby provides a convenient facility for holding the mouthpiece 18 while the user is preparing the device 2 for use.

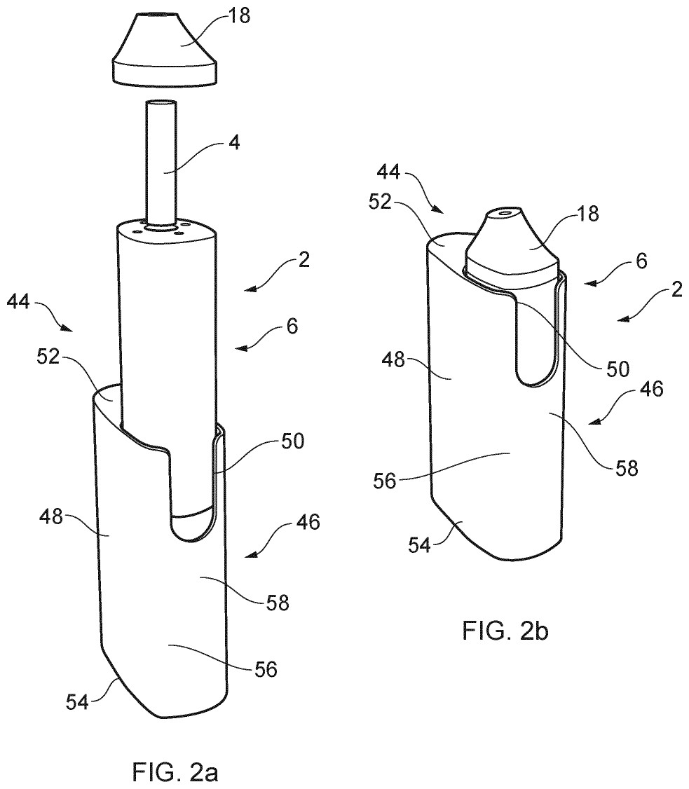

FIGS. 2a and 2b show an aerosol provision device system 44 for generating aerosol from an aerosol generating material. The system 44 comprises a carry case 46 for receiving a device 2. The device 2 is similar to that previously described.

The carry case 46 comprises a case body 48 and a cavity 50 formed in the body 48. The carry case 46 defines an upper, first, or proximal surface 52 and extends to a lower, second or distal surface 54.

The cavity 50 is formed in the upper surface 52 of the carry case 46, extending partway down a length of the carry case 46 towards the lower surface 54. The cavity 50 is shaped and sized to receive the device body 6 in a sliding fit, so that the mouthpiece 18 of the device 2 protrudes at least partially above the upper surface 52 of the carry case 46. In the example shown, the whole mouthpiece 18 extends above the upper surface 52 for ease of use by the user, as described below.

The cavity 50 may comprise an electrical connector/component (not shown), such as a socket/port, which is configured to interface with the electrical connector of the device 2 when the device 2 is disposed in the cavity 50. The body 48 of the carry case may comprise a power source, for example a battery, in order to charge the power source of the device 2 while the device body 6 is within the cavity. In alternative embodiments, the carry case 46 may comprise other means for charging the battery of the device 2, for example using wireless charging.

The carry case 46 may comprise a further electrical connector/component (not shown) disposed on an exterior surface 56 of the carry case 46. The connector may be a socket/port, which can receive a cable to charge the power source of the carry case. Alternatively, the power source of the carry case 46 may be wirelessly chargeable.

The device 2 is usable in the same manner as described in relation to the previous embodiment. The user may use the device 2 by first removing it from the cavity 50 of the carry case 46, performing the steps described above in relation to the use of the device 2, and then replacing the device 2 into the cavity 50 of the carry case 46 after use.

Alternatively, the user may use the device 2 in the manner described above without removing the device 2 from the carry case 46 at any stage. The mouthpiece 18 may protrude wholly above the upper surface 52 of the carry case 46 as described in order to make this type of use more convenient.

The use of a carry case 46 may allow for a reduction in the size of the device 2, for example by reducing the power storage requirements of the power source of the device 2 by provision of a power source in the carry case body 48. The reduced size device 2 may be more convenient to use.

In an embodiment, the carry case 46 may comprise the tertiary attachment means 58 for the mouthpiece 18. The tertiary attachment means 58 could be the same as the secondary attachment means 42 described in relation to the previous embodiment, except disposed in or on the exterior surface 56 of the carry case 46 rather than the housing 8 of the device 2, so that the tertiary attachment means 58 may be used to hold the mouthpiece 18 while the device 2 is in the cavity 50 of the carry case 46. The tertiary attachment means 58 could comprise a magnet, magnets or ferrous material as described in relation to the secondary attachment means 42. This tertiary attachment means 58 could be provided in addition to a secondary attachment means 42 of the device 2.

1. An aerosol provision device, comprising:
a device body;
a chamber formed in the device body and configured to partially receive an article comprising an aerosol-generating material such that a portion of the article protrudes from the device body;
a mouthpiece comprising a passage circumscribed by a wall, the passage configured to receive the protruding portion of the article; and
an attachment means configured to removably attach the mouthpiece to the device body and bring the mouthpiece into engagement with the device body, the device configured such that the protruding portion of the article contacts the wall of the passage when the mouthpiece is engaged with the device body.

2. The aerosol provision device of claim 1, wherein the attachment means is configured to generate a force bringing the mouthpiece and the device body into bearing against one another such that the article is press-fit into the passage.

3. The aerosol provision device of claim 1, wherein the attachment means comprises a magnet formed in each of the device body and the mouthpiece.

4. The aerosol provision device of claim 1, wherein the attachment means comprises a magnet formed in one of the device body or the mouthpiece and a region of ferrous material formed in the other one of the device body or the mouthpiece.

5. The aerosol provision device of claim 3, wherein each magnet is recessed into the respective device body and the mouthpiece.

6. The aerosol provision device of claim 1, wherein the passage of the mouthpiece comprises a first portion having a first cross-sectional area and a second portion having a second cross-sectional area, the first cross-sectional area being greater than the second cross-sectional area, the device configured such that the article contacts the wall of the passage in the first portion of the passage.

7. The aerosol provision device of claim 1, further comprising a secondary attachment means formed in the device body, the secondary attachment means configured to removably receive the mouthpiece such that the chamber of the device is uncovered.

8. The aerosol provision device of claim 7, wherein the secondary attachment means comprises a magnet, magnets or a ferrous material.

9. The aerosol provision device of claim 1, further comprising one or more aerosol generators disposed within the body and in communication with the chamber to generate aerosol from the article.

10. The aerosol provision device of claim 9, wherein the one or more aerosol generators comprises a heater.

11. The aerosol provision device of claim 10, wherein the heater is a resistive heater in heat communication with an interior of the chamber.

12. The aerosol provision device of claim 10, wherein the heater comprises a susceptor in heat communication with an interior of the chamber and a magnetic field generator configured to induce a magnetic field in the susceptor.

13. The aerosol provision device of claim 10, further comprising a power source disposed within the body and in electrical communication with the heater to power the heater.

14. The aerosol provision device of claim 13, further comprising an electrical connection in the device body and in electrical communication with the power source.

15. A system comprising:
the aerosol provision device of claim 1; and
a carry case comprising a body and a cavity formed in the body, the cavity sized to receive the device.

16. The system of claim 15, wherein the carry case comprises a power source disposed in the body of the carry case and a device for communicating power to a power source in the aerosol provision device body when the aerosol provision device is in the cavity.

17. The system of claim 16, wherein the device for communicating power comprises an electrical or wireless connection disposed in the cavity of the carry case and a corresponding electrical or wireless connection disposed in the aerosol provision device body, the electrical or wireless connections configured to connect to one another when the aerosol provision device is received within the cavity.

18. The system of any of claim 15, further comprising a tertiary attachment means formed in an exterior surface of the carry case, the tertiary attachment means configured to removably receive the mouthpiece of the device such that the chamber of the device is exposed.

19. The system of claim 18, wherein the tertiary attachment means comprises a magnet, magnets or a ferrous material.
